(19) United States
(12) Patent Application Publication
(10) Pub. No.: US 2018/0240160 A1
(43) Pub. Date: Aug. 23, 2018

(54) SOCIAL FUNDING SYSTEM USING SOCIAL NETWORK SERVICE AND GAME

(71) Applicants: Shungeun KIM, Sejong (KR); Hyemin LEE, Sejong (KR)

(72) Inventors: Shungeun KIM, Sejong (KR); Hyemin LEE, Sejong (KR)

(21) Appl. No.: 15/751,084

(22) PCT Filed: Jun. 14, 2016
(86) PCT No.: PCT/KR2016/006316

§ 371 Date: Feb. 7, 2018

(30) Foreign Application Priority Data
Aug. 13, 2015 (KR) 10-2015-0114360

(51) Int. Cl. G06Q 30/02; G06Q 40/06; G06Q 50/00; A63F 13/335

(52) U.S. Cl. CPC G06Q 30/0279; A63F 13/335; G06Q 50/01; G06Q 40/06

(57) ABSTRACT

The present invention relates to a social funding system for promoting participation in social funding using a social network service and a game. The social funding system using a social network service and a game, according to the present invention, comprises: a social funding server in which a social funding account is established in cooperation with a social network service account; a social network service server which as a server for providing a social network service, provides the social funding server with a preference for the social network service account linked to the social funding account; a game server which provides an online game and transfers funds to the social funding account according to the game activity index of a sponsor or an investor of the social funding account; and a user terminal which accesses the social funding server to select a social funding account to be sponsored, accesses the social network service server to change the preference, and accesses the game server to generate the activity index.

### TECHNICAL FIELD

The present invention relates to a social funding system, and more particularly, to a social funding system for inducing participation in social funding using a social network service and a game.

### BACKGROUND ART

Various social network services such as Facebook, Twitter and Instagram have become popular with the increase of so-called smart devices such as smart phones and tablet PCs.

Recently, activities known as Crowd Funding, often called Social Funding, which collect funds from a large number of individuals using social network services for sponsorship or investment, have become socially active.

Patent Document discloses a conventional social funding system. FIG. 1 shows a configuration of the conventional social funding system and FIG. 2 shows an operation mechanism of the conventional social funding system.

The conventional social funding system is composed of a founder terminal 1, a social funding server 3, an investor terminal 5 and a bank server 7. The founder terminal 1 sends a business plan, the social funding server 3 provides various kinds of information to the investor terminal 5 and the bank server 7 and then the investor or the bank determines the investment so that the social funding is performed.

The conventional social funding system is a systemization of the investment contest that has been performed in the off-line, so the mechanism is the same as the existing off-line investment offer except that it is performed on-line using the network.

Therefore, the conventional social funding system is generally limited to a limited period of time or until a target amount is achieved. Such limitations, in the sense that there is a limit of time or money, may have no major problem when the target amount can be represented by a numerical value, for example a product development having time limit or a fund-raising campaign with amount limit. But it is often not appropriate in cases of sustained sponsorship, for example in the support of underdeveloped children or in the development of gifted children in sports or the arts.

Also, in the case of general social funding business, many information is shared and exchanged between the business entity and the sponsor or investor at the start of the social funding business. But once the business starts, the interest of the sponsor or investor is lowered and it is difficult to provide information to social investors that the purpose of the original social finding business of faded. Furthermore, there is a problem that it is not easy to introduce sponsors or investors because there is no interesting factor besides social funding itself.

### SUMMARY OF THE INVENTION

### Technical Problem

The present invention has been made in order to solve the above-mentioned problems, and an object of the present invention is providing a social funding system using a social network service and a game, in which information during a promotion of a social funding business is provided to a sponsor or an investor, that can provide a gaming element for the fun and induce active intervention of the sponsor or the investor.

Furthermore, the other object of the present invention is providing a social funding system suitable for social funding projects that require continuous support such as nurturing infants and the gifted.

### Technical Solution

A social funding system using a social network service and a game according to the present invention includes a social funding server in which a social funding account is established in cooperation with a social network service account; a server for providing a social network service which provides a preference of a social network service account linked with the social funding account to the social funding server; a game server for providing online games and transferring the funds to the social funding account according to a game activity index of the sponsor or investor of the social funding account, and a social funding account to be connected to the social funding server to be sponsored, and a user terminal connected to the social funding server to select a social funding account to be sponsored, connected to the social network server to change the preference and generating the activity index by accessing the game server.

### Effect of the Invention

The social funding system using social network service and game according to the present invention activates the social funding by deriving the interest index that reflects the preference of the social network service account and the contribution to the social funding account and allowing the sponsor or the investor to intervene in the interest index to have fun.

### BRIEF DESCRIPTION OF THE DRAWINGS

FIG. 1 is a block diagram of a conventional social funding system

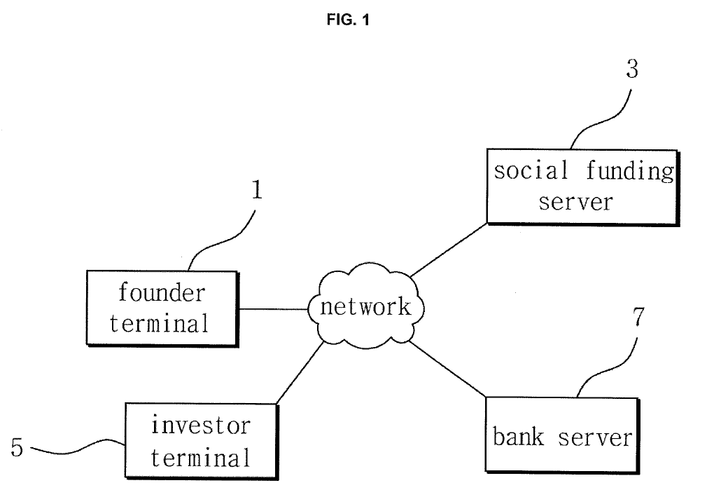

FIG. 2 is a diagram illustrating the operation mechanism of the conventional social funding system

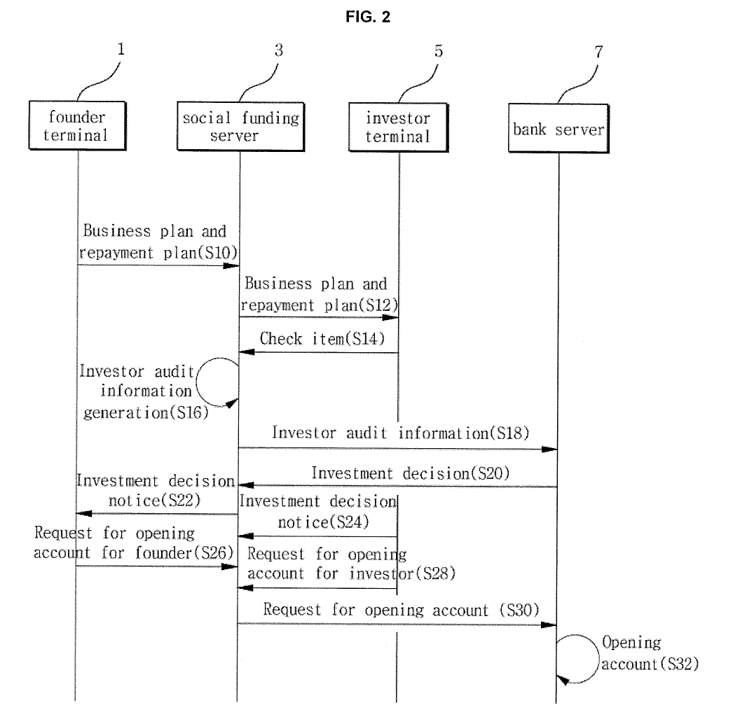

FIG. 3 is a diagram illustrating a configuration of a social funding system using social network service and game according to the present invention

FIG. 4 is a diagram illustrating an operation state of a social funding system using social network service and game according to the present invention

FIG. 5 is a configuration diagram of the social funding server

FIG. 6 is a configuration diagram of a game server

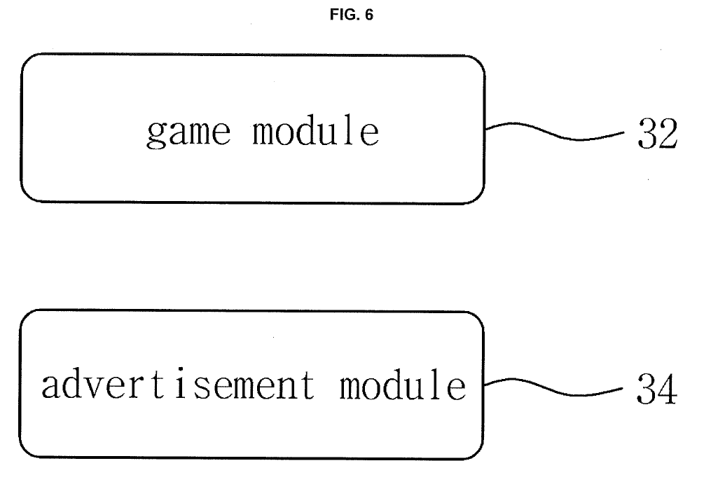

### DETAILED DESCRIPTION OF THE EMBODIMENTS

Hereinafter, a social funding system using social network service and game according to the present invention will be described in detail with reference to the accompanying drawings. For the sake of simplicity, the network and various transmitting and receiving units, which are naturally necessary for the social funding system using the social network service and game, will not be shown and described in order to avoid complexity.

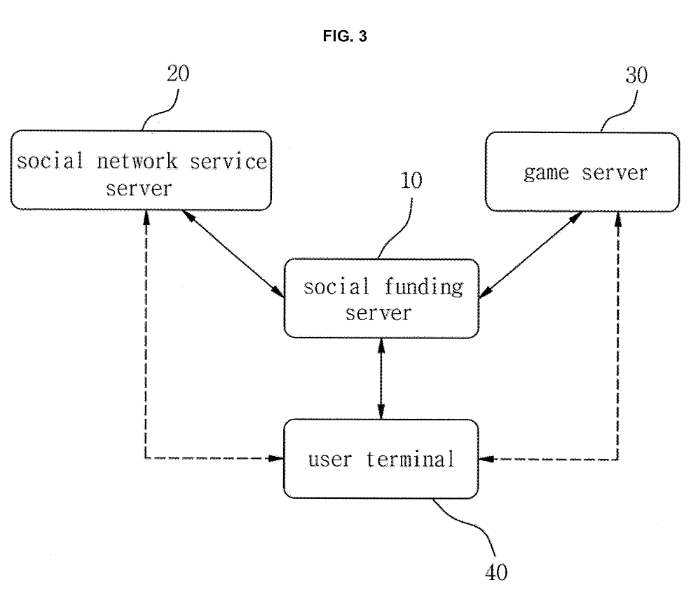

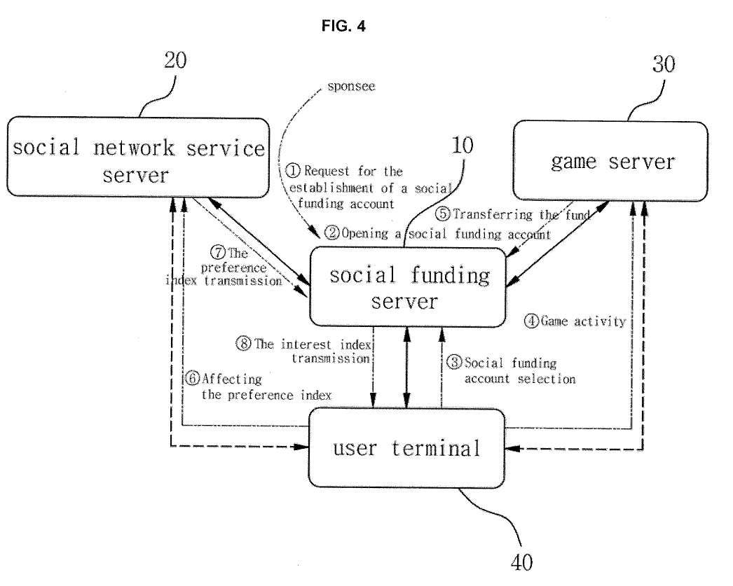

FIG. 3 illustrates a configuration of a social funding system using social network service and game according to the present invention and FIG. 4 illustrates an operation state of a social funding system using social network service and game according to the present invention.

The social funding system using social network service and game according to the present invention includes a social funding server 10, a social network service server 20, hereinafter referred to as ‘SNS server’, a game server 30 and a user terminal 40 and operates as follows.

1 A person who wishes to receive social funding for sponsorship or investment, hereinafter referred to as ‘sponsee’, requests the establishment of a social funding account in the social funding server 10 in cooperation with the SNS server 20.

2 The social funding server 10 opens a social funding account.

3 A sponsor or an investor, hereinafter referred to as ‘sponsor’, selects a social funding account to be supported by the user terminal 40.

4 The social funding is performed by transferring the fund from the game server 30 to the social funding server 10, 5 according to the game activity index of the game server 30 by the sponsor.

6 In this process, sponsor can access the SNS account linked to the social funding account and affect the preference index of the SNS account.

7 The preference index of the SNS account linked to the social funding account is transmitted to the social funding server 10.

8 The social funding server 10 calculates a value, hereinafter referred to as ‘interest index’ reflecting the preference and sponsorship of the SNS account linked to the social funding account and transmits the calculated value to the user terminal 40.

If the sponsor repeats the steps 4 or 6 to change the interest index, the changed interest index is transmitted to the user terminal 40, thereby inducing the interest of the sponsor in the social funding system according to the present invention.

The social funding server 10 establishes a social funding account and transmits and receives data among the SNS server 20, the game server 30 and the user terminal 40. It is a key component in enabling the funding system to work. When the sponsee requests the social funding server 10 to open the social funding account in cooperation with a specific SNS account of the SNS server 20, the social funding server 10 opens the social funding account accordingly. The sponsored money is transferred to the opened social funding account according to the game activity index of the sponsor in the game performed by the user terminal 40. The transferred amount is delivered to the sponsee in real time or after being accumulated for a predetermined period, or when the target amount is reached if the target amount is set.

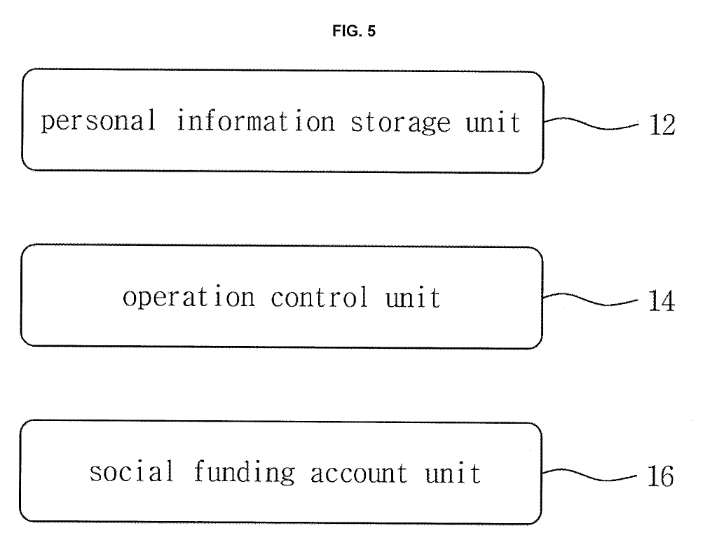

FIG. 5 is a configuration diagram of a social funding server. The social funding server 10 includes a personal information storage unit 12, an operation control unit 14, and a social funding account unit 16.

The personal information storage unit 12 is a component for storing personal information such as a name, a job, an age and a gender of the sponsor and the sponsee. The personal information storage unit 12 provides personal information such as the sponsored person so that the sponsor can decide and select the account to be sponsored, and provides the personal information necessary for the sponsor to access the social funding server 10.

The operation control unit 14 calculates the interest index by the preference index, defined in the description of the SNS server, received from the SNS server 20 and the donation amount transferred from the game server 30 to the social funding account of the social funding account unit 16, and notifies the interest index to the user terminal 40.

An interest index derivation equation can be defined in various ways, for example, as in [Equation 1] below. For example, if the preference index is 100 and the contribution of $10,000 is transferred, the interest index is 200=100+10000/100.

The interest index=The preference index+n hundred dollars(n is 0 or a natural number) Equation 1

To evaluate the preference index more, the interest index can be defined as [Equation 2] by applying a weight.

The interest index=3×The preference index+n hundred dollars(n is 0 or a natural number) Equation 2

In the latter case, the influence of preference index is three times larger than that of the former case, since the preference of the SNS is more important than the size of the contribution. As the SNS activities of the sponsor have a greater influence on the interest index, it can attract more attention to the SNS activities.

In the opposite is case, if the SNS activities are less important than the contribution, the sponsor will be interested in increasing the size of the contribution. The former case can be selected when the size of the contribution is important such as grandparent-grandchild family, and the latter case can be selected when popular response is important such as popular sports.

The interest index may be used to rank within a group of a plurality of social funding accounts satisfying a predetermined condition.

For example, if there is a social funding group in which athletes 1, 2, 3, 4 and 5 belong to A event, and the interest indices are 500, 1000, 300, 2000, 1200, then the order of the athletes is 4, 5, 2, 1, 3. So the sponsor of the lower-ranked athletes 1 and 3 may be motivated to raise their SNS preference index or to make more contributions.

Of course, the interest index may also be used to obtain the overall ranking for the entire social funding account opened in the social funding server 10 as a whole aggregation concept.

The operation control unit 14 can periodically inform the interest index in the group to the user terminal 40 or can inform the interest index to the user terminal 40 when there is a change in the interest index in the group in the sense of motivating the sponsor.

The social funding account unit 16 is a component for establishing a social funding account linked with the SNS account and accepting contributions transferred from the game server 30.

The social funding account opened in the social funding account unit 16 can be set to the target amount or the end time. For example, in the case of social funding for construction of an arena for non-popular sports, it may be terminated by filling in the amount required for the construction of the stadium, and in case of social funding for a sponsorship of non-popular athletes until the Olympic Games, it can be terminated at the end of the Olympic Games. For specific social funding accounts, a sponsorship amount limit and a sponsorship end time can be set for each sponsor.

Since a plurality of social funding accounts are established in the social funding account unit 16, the sponsor can set a priority order for a plurality of social funding accounts. For example, if the first social funding account satisfies the target amount, it is possible to transfer the contribution to the second social funding account, which is the next rank. Alternatively, the period may be set so that the contribution is made to the first social funding account until a predetermined time, and then the contribution is made to the second social funding account.

The SNS server 20 is a server for providing social network services such as Facebook, Twitter, Instagram, etc. Indices for determining the popularity or preference of the SNS account, that is the preference index, is determined for each SNS. The SNS server 20 transmits the preference index of the corresponding SNS account to the social funding server 10 when request for the preference index is received from the social funding server 10. Therefore, in the present invention, the definition of the SNS server 20 is a server that provides an SNS service capable of specifying preference index.

For example, the preference index might be friend number, comment number, like clicked number in Facebook, follower number, retweet number in Twitter, and follower number in Instagram, etc. The preference index can be set in various ways, such as weighting the number of friends and comments, etc., and can be designed to suit the characteristics of the social funding account. For example, the preference index of Facebook may be defined as [Equation 3].

The preference index=friend number+3×comment number+2×like clicked number Equation 3

The game server 30 is an element for providing an online game, and the contribution money transferred to the social funding account is determined according to the activity index of the sponsor in the game server 30. Accordingly, the game server 30 needs to match the information of the sponsor and the social funding account sponsored by the sponsor. This is achieved by registering the social funding account to be sponsored to the game server 30 by the user terminal 40. In the present invention, the online game is not limited to a commonly known mobile game which is a game executed on a mobile terminal, and may be a game performed online using a network even if a desktop PC or console, for example Playstation, XBOX, etc. is used.

A sponsor's activity index is a numerical representation of a user's actions performed in a general online game, such as accessing a game, progressing a game, buying an item, or clicking on an advertisement. For example, the game activity index for sponsors can be defined such as 1 for the game connection, 1 for the duration of the game in minutes, 1 for every 100 cents for the item, and 1 for every click on the advertisement. The contribution amount is transferred to the social funding account of the social funding server 10 according to the game activity index of the sponsor. For example, 1 cent per the game activity index of sponsors can be transferred to the social funding account.

The game server 30 includes a game module 32 for providing games and an advertisement module 34 for providing advertisements.

The game module 32 is a component for operating a game provided to the sponsor. The game module 32 calculates the game activity index of a sponsor directly related to the game, such as connection of a game, progress, purchase of an item, and calculates the game activity index of the sponsor according to the advertisement connection, then transfers the contribution amount to the social funding server 10 according to the game activity index.

The advertisement is presented to the sponsor by the game provided by the game server 30 at the request of the advertiser, and the advertisement fee is paid from the advertiser in return for the presentation to the sponsor.

The present invention introduces the concept of sponsor game activity index so that a part of the advertisement fee can flow to the social fund in the conventional advertisement system using game.

For example, conventionally, a fee of 2 cents per click was paid to the operator of the game server 30, but in the present invention, a fee of 1 cent per click of the advertisement is reflected in the game activity index of the sponsor so as to be a social fund, and the remaining 1 cent is paid to the operator of the game server 30, so that it is possible to eliminate the sense of rejection by the sponsor and induce advertisement click.

Therefore, the advertisement effect increases from the viewpoint of the advertiser and the number of clicks increases instead of decreasing the advertisement fee per click from the viewpoint of the operator of the game server 30. However, the overall advertisement revenue will increase, and the sponsor can support social funding without cost, which can have a positive effect on all three parties.

The advertisement unit 34 is a component that provides advertisements to the game unit 32. The game activity index of the sponsor may be set to be different according to the specific form of the advertisement, for example video advertisement, message advertisement, etc., provided by the advertisement unit 34 when the advertisement is clicked. Therefore, it is possible to induce the sponsor's approach by increasing the game activity in the case of the advertisement which is difficult to induce the sponsor's click in the past.

The game server 30 may provide the sponsor with motivation to participate in social funding.

In situation of a plurality of gamers playing a game together, when the sponsor plays a so-called party game, if there is a sponsor who sponsors the same social funding account or the sponsee of the sponsor at the same party, the contribution can be increased according to the number of sponsors in the same party and the number of sponsees. For example, if three social funding account holders and one sponsee of an A social funding account are at the same party, it is possible to transfer four times of contribution to the social funding server 10 depending on the number of people.

Or if there are achievement goals in the game, for example gathering a certain amount of material in the game, and sponsors who sponsor the same social funding account and the sponsee of the sponsors helped achieve that goal, increased amount of contribution can be transferred to the social funding server 10.

Alternatively, if the sponsor runs a business such as a coffee shop or a restaurant, the sponsor who sponsors the same social funding account in the same game can be informed of the sponsor operating the business.

This motivation increases the bond between the sponsor and the sponsee of the social funding account and induces participation in the social funding so that the social funding system using a social network service and a game according to the present invention operates smoothly.

The user terminal 40 accesses the social funding server 10 to select a social funding account to be sponsored and accesses the SNS server 20 to influence the preference index of the SNS account and accesses the game server 30. It is a smart device commonly known as smart phone, smart pad. The user terminal 40 can install and execute various applications like social funding application, SNS application, game program, etc. provided by the social funding server 10, the SNS server 20 and the game server 30.

In the foregoing, the social funding system using a social network service and a game according to the present invention has been described as an embodiment in which the social funding server 10, the SNS server 20, and the game server 30 are separated. In actual implementation, there may be a form in which two or more of the social funding server 10, the SNS server 20, and the game server 30 are combined because an SNS operating company may run the social funding or games and vice versa.

1. A social funding system using a social network service and a game comprising:
a social funding server establishing a social funding account in cooperation with a social network service account;
a social network service server providing a preference index of a social network service account linked with the social funding account to the social funding server;
a game server providing an online game and transferring contribution to the social funding account according to the game activity index of a sponsor or investor of the social funding account; and
an user terminal accessing the social funding server to select a social funding account to be sponsored, accessing the social network service server to change the preference index, accessing the game server to generate the game activity index.

2. The social funding system using the social network service and the game of claim 1, wherein the social finding server comprises a personal information storage unit for storing personal information of a sponsee of the social funding account and the sponsor or investor;
an operation control unit for calculating an interest index for the social funding account according to the preference index received from the social network service server and the contribution transferred from the game server to the social funding account;
and a social funding account unit for establishing the social funding account linked to the social network service account and accepting a contribution fund transferred from the game server.

3. The social funding system using the social network service and the game of claim 2, wherein the social funding server is configured to include a group of a plurality of social funding accounts, and the operation control unit is configured to notify the interest index in the group to the user terminal when there is a change in the interest index.

4. The social funding system using the social network service and the game of claim 1, wherein a plurality of social funding accounts is provided and set to have priority order; when a first social funding account satisfies the target amount or the ending time, the contribution is transferred to a second social funding account, which is the next rank.
